(19) United States
(12) Patent Application Publication
(10) Pub. No.: US 2020/0049564 A1
(43) Pub. Date: Feb. 13, 2020

(54) SYSTEMS AND METHODS FOR THERMAL IMAGING SYSTEMS

(71) Applicant: Apogee Scientific, LLC, Littleton, CO (US)

(72) Inventors: Scott Edward McLaren, Centennial, CO (US); Neil Vanasse, Thornton, CO (US)

(21) Appl. No.: 16/537,249

(22) Filed: Aug. 9, 2019

Related U.S. Application Data
(60) Provisional application No. 62/716,529, filed on Aug. 9, 2018.
(60) Provisional application No. 62/716,548, filed on Aug. 9, 2018.
(60) Provisional application No. 62/716,559, filed on Aug. 9, 2018.
(60) Provisional application No. 62/716,568, filed on Aug. 9, 2018.
(60) Provisional application No. 62/716,575, filed on Aug. 9, 2018.

(51) Int. Cl. G01J 5/10; H04N 5/33; G01M 3/08; G01M 15/14

(52) U.S. Cl. CPC G01J 5/10; H04N 5/33; G01J 2005/0077; G01M 15/14; G01M 3/083

(57) ABSTRACT

A thermal imaging system for use in maintaining a turbine assembly includes a case, a single pixel detector positioned within the case, at least one optical transportation device, and a prism. The optical transportation device is coupled to the case and configured to direct electromagnetic radiation to the single pixel detector. The prism is coupled to the optical transportation device and configured to direct electromagnetic radiation into the optical transportation device and to the single pixel detector. At least the prism and the optical transportation device are inserted into the turbine assembly and the single pixel detector acquires images of the turbine assembly.

### CROSS REFERENCE TO RELATED APPLICATIONS

This application claims priority to U.S. Provisional Patent Application No. 62/716,529, filed Aug. 9, 2018, entitled “THERMAL IMAGING SYSTEM UTILIZING A SINGLE ELEMENT DETECTOR,” U.S. Provisional Patent Application No. 62/716,548, filed Aug. 9, 2018, entitled “THERMAL IMAGING SYSTEM OPTICAL PROBE,” U.S. Provisional Patent Application No. 62/716,559, filed Aug. 9, 2018, entitled “REAL-TIME DISPLAY OF THERMAL IMAGING DATA,” U.S. Provisional Patent Application No. 62/716,568, filed Aug. 9, 2018, entitled “DETERMINATION OF LEAK EMISSION RATES USING ATMOSPHERIC TRACERS AND MOBILE GAS SENSORS,” and U.S. Provisional Patent Application No. 62/716,575, filed Aug. 9, 2018, entitled “METHOD FOR DETECTING AND PRECISELY LOCATING GAS LEAKS USING A COMBINATION OF DETECTOR TECHNOLOGIES,” the entire contents and disclosures of which are hereby incorporated by reference herein in their entirety.

### BACKGROUND

The field of the disclosure relates generally to thermal imaging and leak detection systems and, more particularly, to thermal imaging systems for inspecting rotary machines.

At least some known components that require periodic maintenance are located within cavities. For example, at least some known rotary machines, such as turbines for aircraft engines and gas and steam powered turbines for power generation and industrial applications, include an outer case and at least one rotor that carries multiple stages of rotating airfoils, i.e., blades, which rotate with respect to the outer case. The turbine includes a compressor section and a turbine section that define a primary flow path inside the turbine. This flow path, combined with a flow path through the combustor, defines a primary cavity within the turbine.

During operation, the components of the rotary machine experience degradation. Accordingly, for at least some known rotary machines, periodic inspections, such as borescope inspections, are performed to assess the condition of the rotary machine in-between service intervals. For turbines, examples of damage observed during inspections include wear (e.g., from incursion of blade tips into the shrouds, particle-induced erosion, water droplet induced erosion, wear due to sliding contact between stationary components), impact (e.g., spallation of thermal barrier coating (TBC) or environmental barrier coating (EBC) from turbine-section components, leading edge burring/bending of compressor blades), cracking (e.g., thermal fatigue, low-cycle fatigue, high-cycle fatigue, creep rupture), edge-of-contact damage between stationary parts, oxidation or hot corrosion of high-temperature metallic sections, static seal degradation, and creep deformation (e.g., of guide vane sidewalls/airfoils, blade platforms, and blade tip shrouds).

During service intervals, the rotary machines are at least partially disassembled to allow repair and/or replacement of damaged components. For example, damaged components of at least some known turbines are primarily repaired at overhaul or component repair facilities, with only limited intervention conducted in the field. Processes used to repair compressor and turbine flow path components include surface cleaning to remove accumulated dirt and oxidation products, stripping and restoration of coated surfaces, crack repair, section replacement, and aero contouring and smoothing. Repairing the components during service intervals reduces the cost to maintain the rotary machine because the cost to repair components is sometimes less than the cost to replace the components. However, sometimes, the components degrade beyond their repair limits between planned service intervals. In addition, heavily distressed components can fail during service and can cause an unplanned outage. Additionally, service intervals may be costly and time-consuming.

For at least some known rotary machines, a tethered device, such as a borescope, is inserted through an opening of the rotary machine, and manipulated within a cavity of the rotary machine for inspection. However, at least some known tethered devices do not access all locations of the rotary machine. In particular, some non-rotating components in at least some known rotary machines are difficult to access with a tethered device. Furthermore, damage detected during inspection is typically unmitigated until the machine is at least partially disassembled during service.

Moreover, at least some known visual inspection methods use borescopes that include a liquid nitrogen cooled focal plane array detector. However, at least some known focal plane array detectors are large, and, as such, require the opening of the rotary machine to be large enough to accommodate the focal plane array detector. Large openings within the rotary machine may require extensive modifications to the rotary machine and may prevent the focal plane array detector from use with existing rotary machines.

### BRIEF DESCRIPTION

In one aspect, a thermal imaging system for use in maintaining a turbine assembly is provided. The thermal imaging system includes a case, a single pixel detector positioned within the case, at least one optical transportation device, and a prism. The optical transportation device is coupled to the case and configured to direct electromagnetic radiation to the single pixel detector. The prism is coupled to the optical transportation device and configured to direct electromagnetic radiation into the optical transportation device and to the single pixel detector. At least the prism and the optical transportation device are inserted into the turbine assembly and the single pixel detector acquires images of the turbine assembly.

In another aspect, a thermal imaging system for use in maintaining a turbine assembly is provided. The thermal imaging system includes a case, a focal plane array detector positioned within the case, an optical transportation device, and a prism. The optical transportation device is coupled to the case and configured to direct electromagnetic radiation to the focal plane array detector. The optical transportation device includes a plurality of optical elements. The prism is coupled to the optical transportation device and configured to direct electromagnetic radiation into the optical transportation device and to the focal plane array detector. At least the prism and the optical transportation device are inserted into the turbine assembly and the focal plane array detector acquires images of the turbine assembly.

In yet another aspect, a method of maintaining a turbine assembly is provided. The method includes inserting a thermal imaging system into the turbine assembly. The thermal imaging system includes a case, a single pixel detector positioned within the case, at least one optical transportation device coupled to the case, and a prism coupled to the at least one optical transportation device. The method also includes positioning the prism proximate at least one surface within the turbine assembly. The method further includes directing electromagnetic radiation emitted by the at least one surface into the at least one optical transportation device using the prism. The method also includes directing the electromagnetic radiation from the prism to the into the single pixel detector using the at least one optical transportation device. The method further includes acquiring an image of the at least one surface using the single pixel detector.

### DRAWINGS

These and other features, aspects, and advantages of the present disclosure will become better understood when the following detailed description is read with reference to the accompanying drawings in which like characters represent like parts throughout the drawings, wherein:

FIG. 1 is a cross-sectional schematic view of an exemplary rotary machine and an exemplary thermal imaging system;

FIG. 2 is a perspective cut-away view of the thermal imaging system shown in FIG. 1;

FIG. 3 is a perspective view of the thermal imaging system positioned proximate a plurality of blades within the rotary machine shown in FIG. 1 with portions of the rotary machine removed for clarity;

FIG. 4 is a perspective view of a second thermal imaging system including a second optical transportation device for use with the rotary machine shown in FIG. 1;

FIG. 5 is a flow diagram of the thermal imaging system operating within the rotary machine shown in FIG. 1;

FIG. 6 is a perspective view of the thermal imaging system receiving electromagnetic radiation from a plurality of blades within the rotary machine shown in FIG. 1 with portions of the rotary machine removed for clarity;

FIG. 7 is a display displayed on the user interface shown in FIG. 1;

FIG. 8 is a display displayed on the user interface shown in FIG. 1;

FIG. 9 is a display displayed on the user interface shown in FIG. 1;

FIG. 10 is a display displayed on the user interface shown in FIG. 1;

FIG. 11 is a display displayed on the user interface shown in FIG. 1;

FIG. 12 is a perspective view of a third thermal imaging system including a second prism, a third optical transportation device, and a second detector unit for use with the rotary machine shown in FIG. 1;

FIG. 13 is a perspective cut-away view of the third thermal imaging system shown in FIG. 12;

FIG. 14 is a side cut-away view of the third thermal imaging system shown in FIG. 12;

FIG. 15 is a schematic view of the second prism and the third optical transportation device shown in FIG. 12;

FIG. 16 is a flow diagram of a method of maintaining the rotary machine shown in FIG. 1; and

FIG. 17 is a flow diagram of a method 1100 of acquiring and displaying data associated with the rotary machine shown in FIG. 1.

Unless otherwise indicated, the drawings provided herein are meant to illustrate features of embodiments of this disclosure. These features are believed to be applicable in a wide variety of systems comprising one or more embodiments of this disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

As used herein, the terms “processor” and “computer,” and related terms, e.g., “processing device,” “computing device,” and “controller” are not limited to just those integrated circuits referred to in the art as a computer, but broadly refers to a microcontroller, a microcomputer, an analog computer, a programmable logic controller (PLC), and application specific integrated circuit (ASIC), and other programmable circuits, and these terms are used interchangeably herein. In the embodiments described herein, “memory” may include, but is not limited to, a computer-readable medium, such as a random access memory (RAM), a computer-readable non-volatile medium, such as a flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a touchscreen, a mouse, and a keyboard. Alternatively, other computer peripherals may also be used that may include, for example, but not be limited to, a scanner. Furthermore, in the exemplary embodiment, additional output channels may include, but not be limited to, an operator interface monitor or heads-up display. Some embodiments involve the use of one or more electronic or computing devices. Such devices typically include a processor, processing device, or controller, such as a general purpose central processing unit (CPU), a graphics processing unit (GPU), a microcontroller, a reduced instruction set computer (RISC) processor, an ASIC, a PLC, a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are exemplary only, and thus are not intended to limit in any way the definition and/or meaning of the term processor and processing device.

Embodiments described herein provide a thermal imaging system for use in maintaining rotary machines. The thermal imaging system includes a detector and/or an optical transportation device that is small enough to enable the thermal imaging system to be inserted into small borescope holes within the turbine assembly. More specifically, in a first embodiment, the thermal imaging system includes a single-pixel detector sized and shaped to allow at least a portion of the thermal imaging system to be inserted into small borescope holes within the turbine assembly. The single pixel detector has a small field of view (1 square millimeter (mm) or less) and measures only a single point within the turbine assembly at a given time. The small field of view allows electromagnetic radiation to travel through a small diameter optical transportation device and a small diameter hole in turbine assembly. Small borescope holes within the turbine assembly allow the thermal imaging system to be used with existing turbine assemblies. Accordingly, using a single pixel detector enables a size of the optical transportation device to be reduced to fit within small borescope holes within the turbine assembly. Additionally, the single pixel detector does not require as much cooling as other detectors, such as focal plane array detectors. As such, a small thermal electric cooler can be used to cool the thermal imaging system, allowing the thermal imaging system to be inserted into small borescope holes within the turbine assembly. Furthermore, the optical transportation device may include fiber optic cables that enable increased access to difficult-to-reach locations within the turbine assembly and reduce the amount of time the rotary machine is out of service for maintenance. Finally, the thermal imaging system may be installed within the turbine assembly during normal operations. Accordingly, the thermal imaging system provides real-time feedback on the turbine assembly operating conditions.

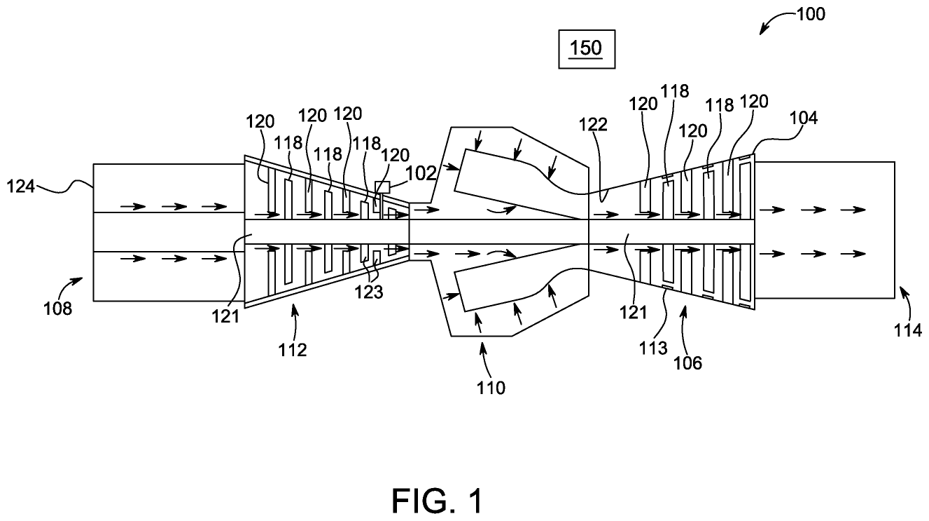

FIG. 1 is a cross-sectional schematic view of an exemplary rotary machine and a thermal imaging system 102. In the exemplary embodiment, the rotary machine includes a turbine assembly 100. In alternative embodiments, thermal imaging system 102 is used to perform maintenance on any component within a cavity. For example, in some embodiments, thermal imaging system 102 performs maintenance on, without limitation, any of the following: rotating machinery (e.g., a compressor, a blower, a pump, a turbine, a motor, and a generator), storage tanks, heat exchangers, boilers, and pipes.

In the exemplary embodiment, turbine assembly 100 includes an outer case 104, a turbine 106, an inlet 108, a combustor 110, a compressor 112, and an exhaust 114. Fluid flows from inlet 108, through compressor 112, through combustor 110, through turbine 106 and is discharged through exhaust 114. Together, outer case 104, blades 118, guide vanes 120, and shrouds 113 define a primary flow path inside compressor 112 and turbine 106 of turbine assembly 100. This flow path, combined with a flow path through combustor 110, defines a primary cavity within turbine assembly 100. In alternative embodiments, turbine assembly 100 is configured in any manner that enables turbine assembly 100 to operate as described herein.

Also, in the exemplary embodiment, compressor 112 and turbine 106 include airfoils configured to direct fluid through turbine assembly 100. In particular, compressor 112 and turbine 106 include blades 118 and guide vanes 120. Blades 118 are operably coupled with rotating shaft 121 such that blades 118 rotate when rotating shaft 121 rotates. Guide vanes 120 and shrouds 113 are stationary components and are coupled to an inner surface 122 of outer case 104. Blades 118 and guide vanes 120 generally are positioned alternatingly along the rotor axis within turbine assembly 100. In alternative embodiments, compressor 112 and/or turbine 106 includes any airfoils that enable turbine assembly 100 to operate as described herein.

In addition, in the exemplary embodiment, thermal imaging system 102 is configured to be inserted into the primary cavity of turbine assembly 100. Accordingly, thermal imaging system 102 facilitates maintenance of turbine assembly 100. For example, thermal imaging system 102 facilitates maintenance of turbine assembly 100 at locations that are difficult to access from an exterior of turbine assembly 100, such as the primary cavity of turbine assembly 100.

During operation, thermal imaging system 102 is used to observe and/or maintain any interior components of turbine assembly 100. For example, in some embodiments, thermal imaging system 102 is positioned adjacent an interior surface 123 of turbine assembly 100. Interior surface 123 is any surface within the primary cavity of turbine assembly 100. For example, in some embodiments interior surface 123 includes, without limitation, surfaces of blades 118, guide vanes 120, shrouds 113, outer case 104, and combustor 110. In some embodiments, thermal imaging system 102 detects a characteristic of interior surface 123. For example, in some embodiments, thermal imaging system 102 is used to generate an image of interior surface 123 and the image is examined to determine whether repairs are necessary. Thermal imaging system 102 can withstand the hostile environment within turbine assembly 100, and, as such, can be inserted into the primary cavity of turbine assembly 100 while turbine assembly 100 is running and can gather data with turbine assembly 100 running at full load.

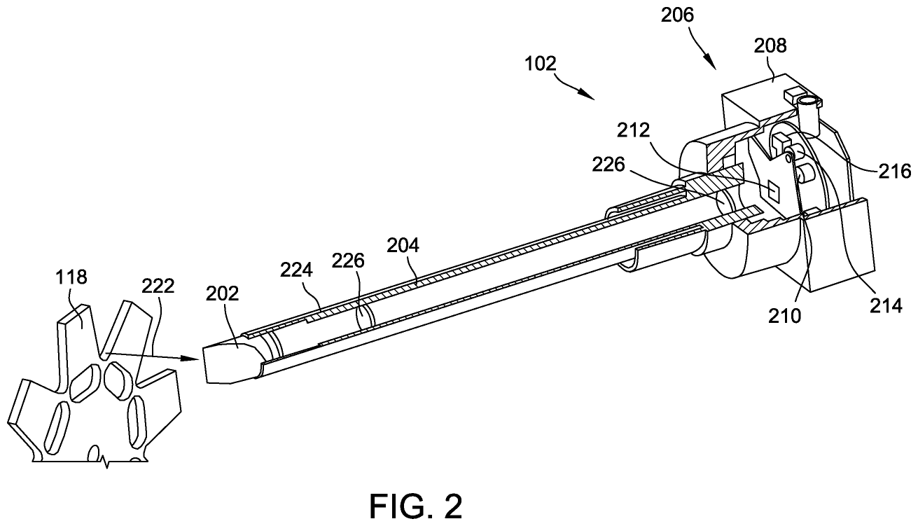

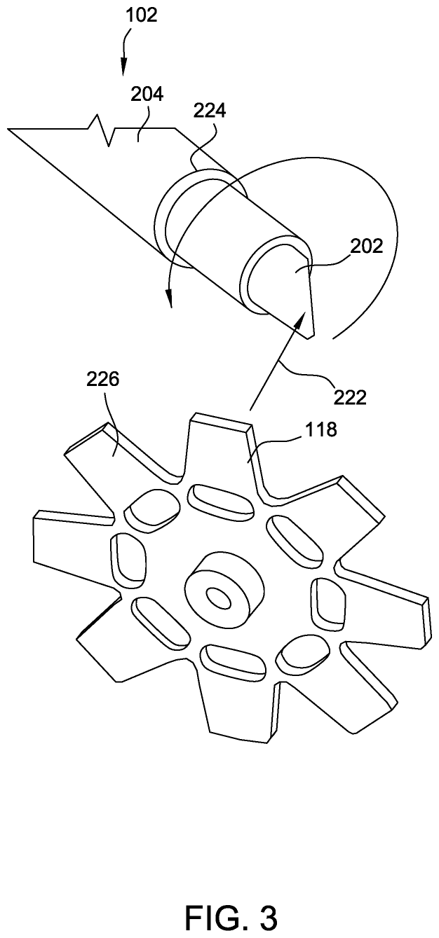

FIG. 2 is a perspective cut-away view of thermal imaging system 102. FIG. 3 is a perspective view of thermal imaging system 102 positioned proximate blades 118 within turbine 106 with portions of turbine assembly 100 removed for clarity. Thermal imaging system 102 includes a prism 202, at least one optical transportation device 204, and a detector unit 206. Detector unit 206 includes a case 208, at least one detector 210, a bandpass filter 212, a processor 214, and a cooler 216. In alternative embodiments, thermal imaging system 102 includes any components that enable thermal imaging system 102 to operate as described herein.

In the exemplary embodiment, prism 202 includes a transparent optical element configured to receive electromagnetic radiation 222 and refract, reflect, and/or separate the received electromagnetic radiation 222. In the exemplary embodiment, electromagnetic radiation 222 includes infrared radiation. In alternative embodiments, electromagnetic radiation 222 includes any wavelength of electromagnetic radiation that enables thermal imaging system 102 to operate as described herein. As shown in FIG. 3, prism 202 is configured to rotate in order to collect electromagnetic radiation 222. Additionally, prism 202 has a shape configured to refract electromagnetic radiation 222 into optical transportation device 204. Accordingly, prism 202 is configured to receive electromagnetic radiation 222 and refract electromagnetic radiation 222 into optical transportation device 204 toward detector unit 206. In alternative embodiments, prism 202 may include any shape that enables thermal imaging system 102 to operate as described herein. Moreover, in the exemplary embodiment, prism 202 includes a sapphire prism. In alternative embodiments, prism 202 may be any type of prism that enables thermal imaging system 102 to operate as described herein, including, without limitation, a silicon prism.

In the exemplary embodiment, optical transportation device 204 is coupled to prism 202 and detector unit 206. Optical transportation device 204 is configured to receive electromagnetic radiation 222 from prism 202 and direct electromagnetic radiation 222 into detector unit 206. In the exemplary embodiment, optical transportation device 204 includes a tube 224 and at least one optical element 226 configured to direct electromagnetic radiation 222 from prism 202 to detector unit 206. In the exemplary embodiment, optical element 226 includes a lens configured to focus electromagnetic radiation 222. In alternative embodiments, optical elements 226 includes any optical element that enables optical transportation device 204 to operate as described herein. In the exemplary embodiment, optical transportation device 204 includes two optical elements 226. In alternative embodiments, optical transportation device 204 includes any number of optical elements 226 that enables optical transportation device 204 to operate as described herein. In the exemplary embodiment, thermal imaging system 102 includes a single optical transportation device 204. In alternative embodiments, thermal imaging system 102 includes any number of optical transportation devices 204 that enables thermal imaging system 102 to operate as described herein.

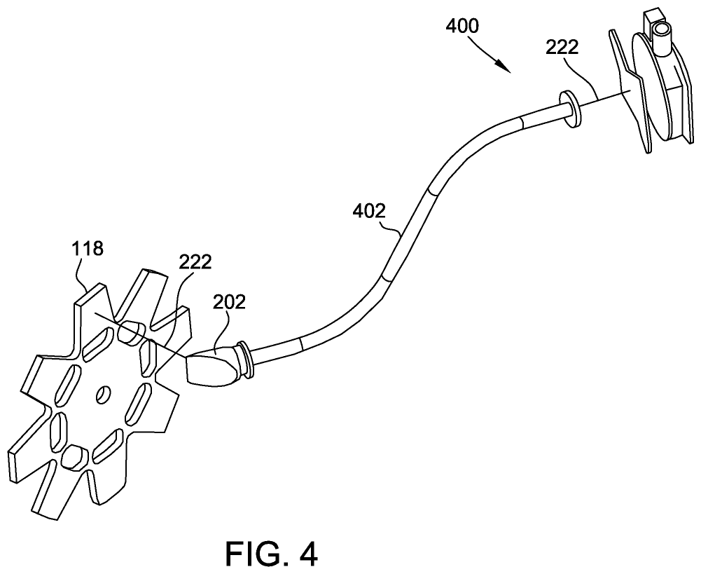

FIG. 4 is a perspective view of a second thermal imaging system 400 including a second optical transportation device 402. In the exemplary embodiment, second thermal imaging system 400 is substantially similar to thermal imaging system 102 except that second thermal imaging system 400 includes second optical transportation device 402 rather than optical transportation device 204. In the exemplary embodiment, second optical transportation device 402 includes fiber optics and/or light pipes configured to configured to direct electromagnetic radiation 222 from prism 202 to detector unit 206. Fiber optics and/or light pipes are configured to bend such that electromagnetic radiation 222 can be directed around objects. As such, second optical transportation device 402 enables second thermal imaging system 400 to collect electromagnetic radiation 222 and direct electromagnetic radiation 222 around objects from prism 202 to detector unit 206. Optical transportation device 204 requires a path of electromagnetic radiation 222 to be straight, and, as such, restricts the distance from interior surface 123 that thermal imaging system 102 can detect electromagnetic radiation 222. In contrast, second optical transportation device 402 enables second thermal imaging system 400 to collect electromagnetic radiation 222 and direct electromagnetic radiation 222 through a non-linear path around objects from prism 202 to detector unit 206 over greater distances.

In the exemplary embodiment, as shown in FIG. 2, case 208 encloses and protects detector 210, bandpass filter 212, processor 214, and cooler 216. Detector 210 may be a single detector 210 or a plurality of detectors 210. When detector unit 206 includes a plurality of detectors 210, each detector 210 may be configured to detect a predetermined wavelength of electromagnetic radiation 222, and detector unit 206 may be configured to change detector 210 depending on a detected wavelength of electromagnetic radiation 222. For example, some detectors 210 may be configured to detect electromagnetic radiation 222 from objects that have a certain temperature range, and, as such, emit electromagnetic radiation within a predetermined range of wavelengths. Bandpass filter 212 is configured to detect the wavelength of electromagnetic radiation 222 and send the detected wavelength to processor 214. Processor 214 is then configured to determine which detector 210 of the plurality of detectors 210 to use to detect and record electromagnetic radiation 222 based on the detected wavelength of electromagnetic radiation 222 and/or a temperature of the detected object. In some embodiments, each detector 210 may include a focal plane array detector. In other embodiments, each detector 210 may include a single pixel detector. Detector 210 may be any type of optical detector that enables detector unit 206 to operate as described herein.

Processor 214 includes at least one processing device (not shown in FIG. 2) and at least one memory device (not shown in FIG. 2) for executing instructions to operate thermal imaging system 102. In alternative embodiments, thermal imaging system 102 includes any processor 214 that enables system 102 to operate as described herein. In some embodiments, processor 214 is omitted.

In some embodiments, thermal imaging system 102 also includes cooler 216. In other embodiments, thermal imaging system 102 does not include cooler 216. Cooler 216 is configured to cool thermal imaging system 102. More specifically, cooler 216 is configured to cool prism 202, optical transportation device 204, case 208, detector 210, bandpass filter 212, and/or processor 214. In some embodiments, cooler 216 is specifically configured to cool detectors 210. Specifically, in some embodiments, when detectors 210 include a focal plane array detector, cooler 216 may include a liquid nitrogen cooler configured to cool the focal plane array detector. In other embodiments, when detectors 210 include a single pixel detector, cooler 216 may include a thermal electric cooler. Thermal electric coolers are typically, smaller, cheaper, and consume less power than liquid nitrogen coolers. In alternative embodiments, cooler 216 may be any type of cooler that enables thermal imaging system 102 to operate as described herein.

In the exemplary embodiment, thermal imaging system 102 is sized and shaped to fit within turbine assembly 100 (shown in FIG. 1) and/or to travel through turbine assembly 100, such as through the primary cavity of turbine assembly 100 (shown in FIG. 1). For example, prism 202, optical transportation device 204, and detector unit 206 all have a height, length, and width that are less than a clearance required to fit within the primary cavity of turbine assembly 100. In alternative embodiments, thermal imaging system 102 includes any size and shape that enables thermal imaging system 102 to operate as described herein. Additionally, in the exemplary embodiment, prism 202 and optical transportation device 204 are sized and shaped to be inserted into a borescope hole within turbine assembly 100 such that prism 202 and optical transportation device 204 extend into the primary cavity of turbine assembly 100 while detector unit 206 remains outside of turbine assembly 100.

Also, in the exemplary embodiment, thermal imaging system 102 includes a user interface 150 (shown in FIG. 1) configured to display information relating to thermal imaging system 102 for interpretation by the user. For example, in some embodiments, user interface 150 displays images of interior surface 123 of turbine assembly 100. In some embodiments, user interface 150 allows a user to input and/or view information relating to control of thermal imaging system 102. In an exemplary embodiment, user interface 150 is configured to display information relating to the state of one or more of prism 202, optical transportation device 204, case 208, detector 210, bandpass filter 212, and/or processor 214 for interpretation by the user. Processor 214 translates user inputs via user interface 150 into commands and sends information to thermal imaging system 102. In some embodiments, users control thermal imaging system 102 in real time using user interface 150, such as through a joystick, keyboard, touchscreen or other interface having similar function. In other embodiments, thermal imaging system 102 is controlled partially or wholly according to a pre-programmed routine. In some embodiments, a user inputs information, such as operation goals or conditional directions and thermal imaging system 102 is at least partially automated. In further embodiments, information, such as information received by thermal imaging system 102, control data sent to thermal imaging system 102, and additional user inputs or state information (e.g., location, time, orientation, datalink quality, battery levels, failure mode indicators), is logged into the memory device (not shown in FIG. 2).

In the exemplary embodiment, thermal imaging system 102 may also include a transceiver (not shown in FIG. 2). The transceiver is communicatively coupled with thermal imaging system 102 and is configured to send information to and receive information from user interface 150. In the exemplary embodiment, the transceiver and user interface 150 communicate wirelessly. In alternative embodiments, thermal imaging system 102 and user interface 150 communicate in any manner that enables system 102 to operate as described herein. For example, in some embodiments, user interface 150 and the transceiver exchange information through a wired link extending between the transceiver and user interface 150.

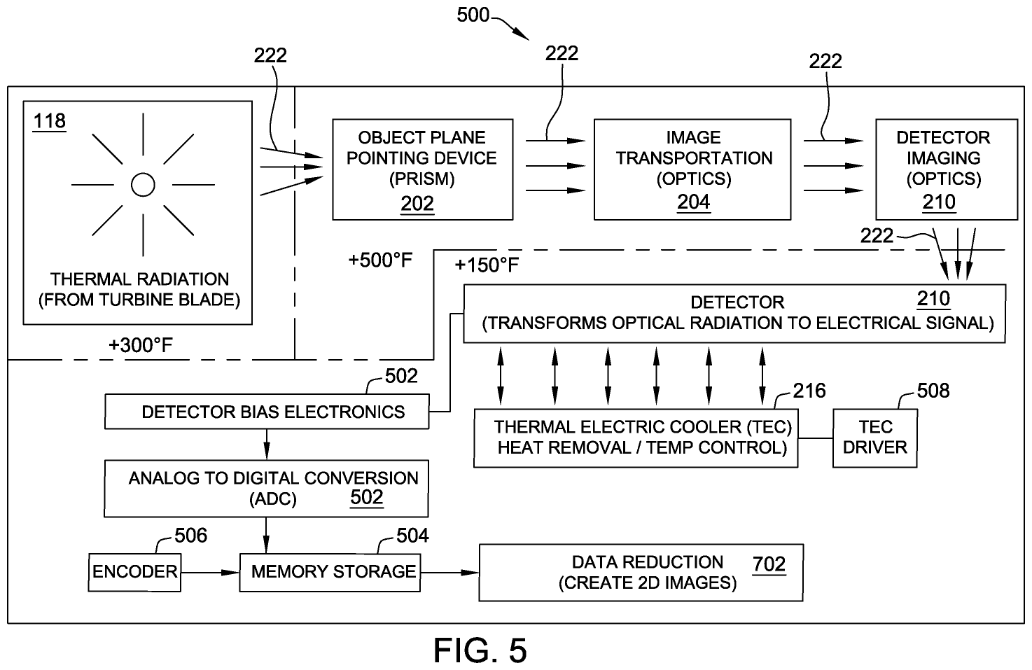

FIG. 5 is a flow diagram 500 of thermal imaging system 102 operating within turbine assembly 100. During operation, interior surface 123 produces electromagnetic radiation 222, and prism 202 receives electromagnetic radiation 222. Prism 202 directs electromagnetic radiation 222 into optical transportation device 204, and optical transportation device 204 directs electromagnetic radiation 222 into detector unit 206 and detector 210. Detector 210 transforms electromagnetic radiation 222 into analog electrical signals and sends the electrical signals to bias electronics 502 within detector 210. Bias electronics 502 converts the analog electrical signals into digital electrical signals and sends the digital electrical signals to a memory device 504. An encoder 506, a program configured to create thermal images from the digital electrical signals stored within memory device 504, converts the digital electrical signals stored within memory device 504 into thermal images. The primary cavity within turbine assembly 100 may have a temperature in excess of 3000° F., and cooler 216 maintains prism 202 and optical transportation device 204 at a temperature of about 500° F. Additionally, cooler 216 maintains detector 210 and processor 214 at a temperature of about 150° F. or less. Cooler 216 may be controlled by a thermal electric cooler driver 508.

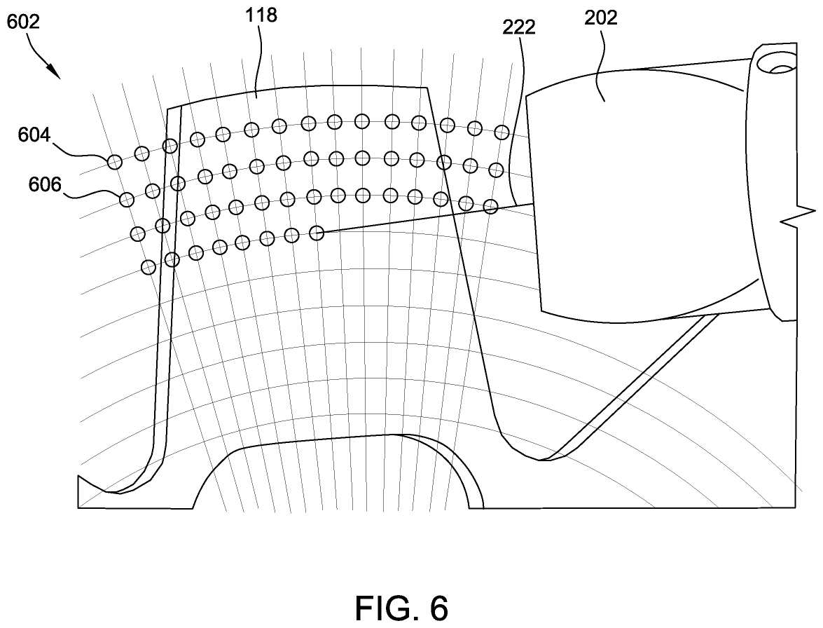

FIG. 6 is a perspective view of thermal imaging system 102 receiving electromagnetic radiation 222 from blades 118 within turbine 106 with portions of turbine assembly 100 removed for clarity. In the exemplary embodiment, detector 210 includes a single pixel detector configured to receive a single pixel of electromagnetic radiation 222 during a predetermined timeframe. As shown in FIG. 6, blades 118 spin while thermal imaging system 102 receives electromagnetic radiation 222 from blades 118. More specifically, thermal imaging system 102 is inserted into turbine assembly 100 such that prism 202 is positioned proximate blades 118. In some embodiments, thermal imaging system 102 is inserted into turbine assembly 100 while turbine assembly 100 is operating normally. In other embodiments, thermal imaging system 102 is inserted into turbine assembly 100 while turbine assembly 100 is operating in an inspection mode configured to spin blades 118 without fully operating turbine assembly 100. In alternative embodiments, thermal imaging system 102 is inserted into turbine assembly 100 while turbine assembly 100 is operating in any operational mode that enables thermal imaging system 102 to operate as described herein.

As shown in FIG. 6, as blades 118 spin, thermal imaging system 102 receives electromagnetic radiation 222 from a plurality of collection locations 602 on interior surface 123 of blades 118. Additionally, thermal imaging system 102 is continually repositioned within turbine assembly 100 such that thermal imaging system 102 collects electromagnetic radiation 222 from a first collection location 604 during a first rotation of blades 118 and from a second collection location 606 during a second rotation of blades 118. That is, thermal imaging system 102 is continually repositioned within turbine assembly 100 such that thermal imaging system 102 collects electromagnetic radiation 222 from a different location on blades 118 with every rotation of blades 118. Accordingly, thermal imaging system 102 can image all of blades 118 using a single-pixel detector. In alternative embodiments, a scanning system (not shown) repositions the field of view of thermal imaging system 102 rather than repositioning thermal imaging system 102. Additionally, thermal imaging system 102 may also include a trigger system (not shown) that synchronizes the rotation of blades 118 and the acquisition of images by detector 210.

Detector 210 has a small field of view (1 square millimeter (mm) or less) and measures only a single point on blades 118 at any instant. The small field of view allows electromagnetic radiation 222 to travel through a small diameter optical transportation device 204 and a small diameter hole in turbine assembly 100. The raw signal coming from detector 210 is a series of triangular waves. The sharp discontinuities in turbine assembly 100 may be used as markers for the edge of each blade 118. The data stream is fed into a digital phase locked loop algorithm which determines position of blades 118 with a very high degree of accuracy. When gathering data in a tangential direction, thermal imaging system 102 scans using a signal from detector 210 over a time domain. Because time can be converted back to position using encoded data, absolute positions can be recorded each time detector 210 is integrated, creating the same pixel point information as would be generated from a single image capture from a focal plane array.

During one revolution of blades 118, thermal imaging system 102 generates an image that is 1 pixel high by approximately 4000 pixels wide consisting of a single pixel high line across each blade 118. Small offsets in rotation of prism 202 about an axis enable scanning in the radial direction. The rotation of prism 202 creates a scan line offset in the radial direction and the same data is collected in the tangential direction again. This process is repeated until all the raw data for a full image of each blade 118 is generated and stored in memory with encoder position data.

The time required to generate a 2D pixel map varies with application. For example, in turbine assembly 100 operating at 30,000 rotations per minute, blades 118 make a full revolution every 2 millisecond (ms), and prism 202 rotates to the next scan line in 2 ms. As such, a full 500-pixel high image of the entire rotor takes approximately 2 seconds to complete. In some embodiments, images of only a portion of the rotor may be acquired to reduce the scan time.

The data stored in memory device 504 is raw data, and encoder 506 uses algorithms to identify where the pixel point was taken. As shown in FIG. 6, detector 210 acquires data in a polar coordinate system as blades 118 rotate by prism 202. The algorithm relies on these accurate position details, so that an image of the correct blade 118 is compiled. Processor 214 maps each pixel point location with references to the time domain as it is related to turbine assembly 100 rotational speed and the radial distance of the imaging location. Using a mathematical function, the actual imaging position on blade 118 is returned and stored into an array with three values (x-location/y-location/temperature value) for each pixel point. Once this array is generated, a second algorithm builds 2D images of each blade 118 using the first two array values as x, y position and the third value as the pixel value which is usually a false color representation of blade 118 temperature. After electromagnetic radiation 222 has been transformed to an electrical signal by detector 210, encoder 506 data are saved with the raw detector data and an algorithm is used to reconstruct the 2D thermal image. For a typical application, 2D images of blade 118 temperatures are available in a few seconds.

Temperature measurements are made using infrared thermography. Infrared thermography is a technique in which radiance (the infrared radiation emitted from an object) is measured and related back to the temperature of the object. Turbine assembly 100 temperatures in an operating engine will typically be about 1400° F. to about 2000° F., with an optimal wavelength range for detector 210 of about 1.5 μm to about 2.5 μm. However, objects within turbine assembly 100 may be much cooler. For example, blades 118 of compressor 112 typically radiate electromagnetic radiation 222 at a wavelength of 10 μm or longer. Thermal imaging system 102 has different detectors 210 that allow operation over a range of wavelengths from about 0.9 μm to about 12.0 μm.

In a first configuration, thermal imaging system 102 includes a filter wheel containing up to four optical filters (not shown) mounted in the optical path near the detector. Data at one wavelength is collected and the filter wheel is rotated to allow data at the next wavelength to be measured. In a second configuration, thermal imaging system 102 includes an arrangement of beam splitters (not shown) that split electromagnetic radiation 222 and sends electromagnetic radiation 222 to multiple detectors 210, each with its own optical filter. The first configuration directs all electromagnetic radiation 222 to a single detector 210, resulting in a higher accuracy signal. The second configuration measures all wavelengths simultaneously, increasing the speed of the measurement and eliminating errors associated with engine temperature changing between measurements at different wavelengths.

Thermal imaging system 102 may be installed in different orientations within turbine assembly 100 and may rotate prism 202 in any orientation. As such, thermal imaging system 102 may be oriented normal to a plane of deflection and view deformation of blades 118 as each blade 118 experiences different operational parameters and loads. To acquire three-dimensional images from two dimensional cameras, a binocular arrangement of two thermal imaging systems 102 is used. In this arrangement, thermal imaging system 102 generates 3D point cloud images of temperature data.

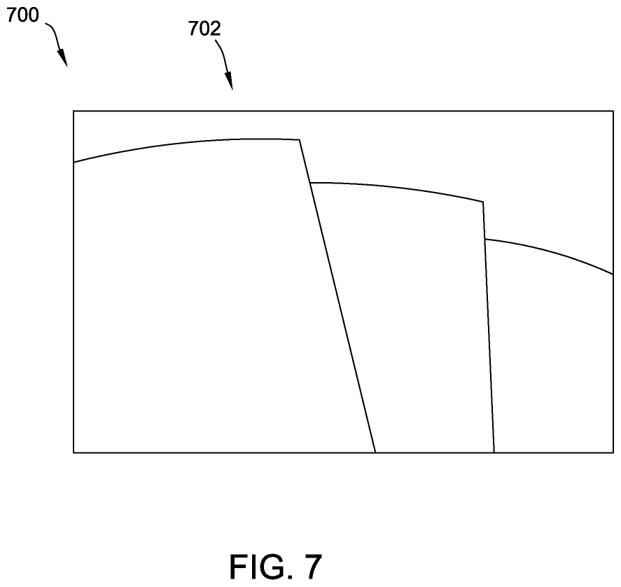

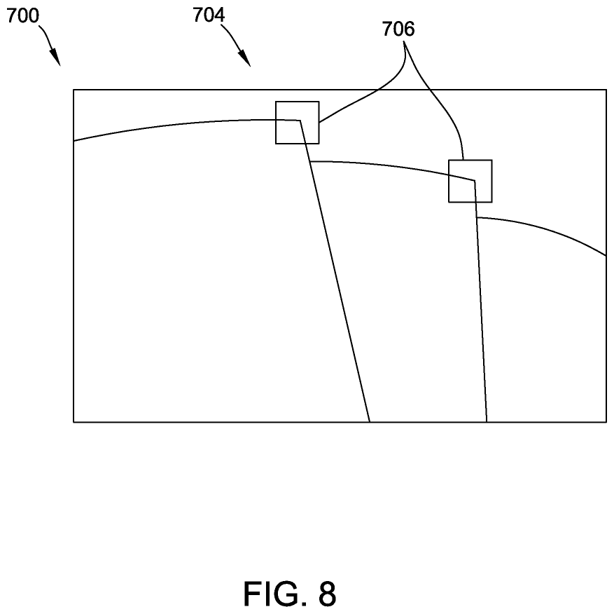

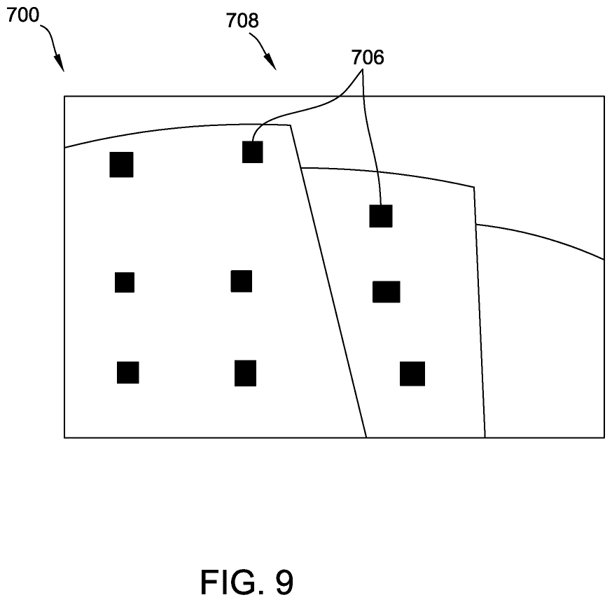

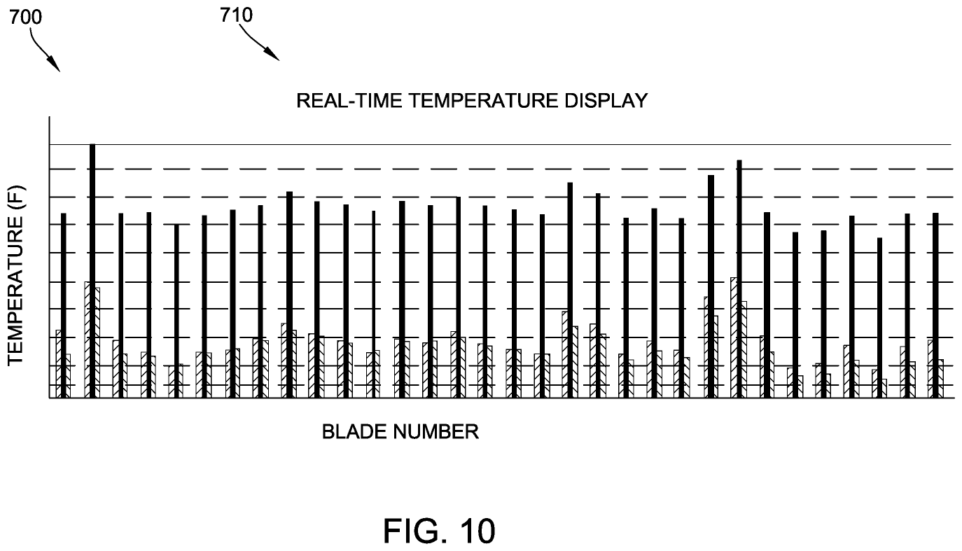

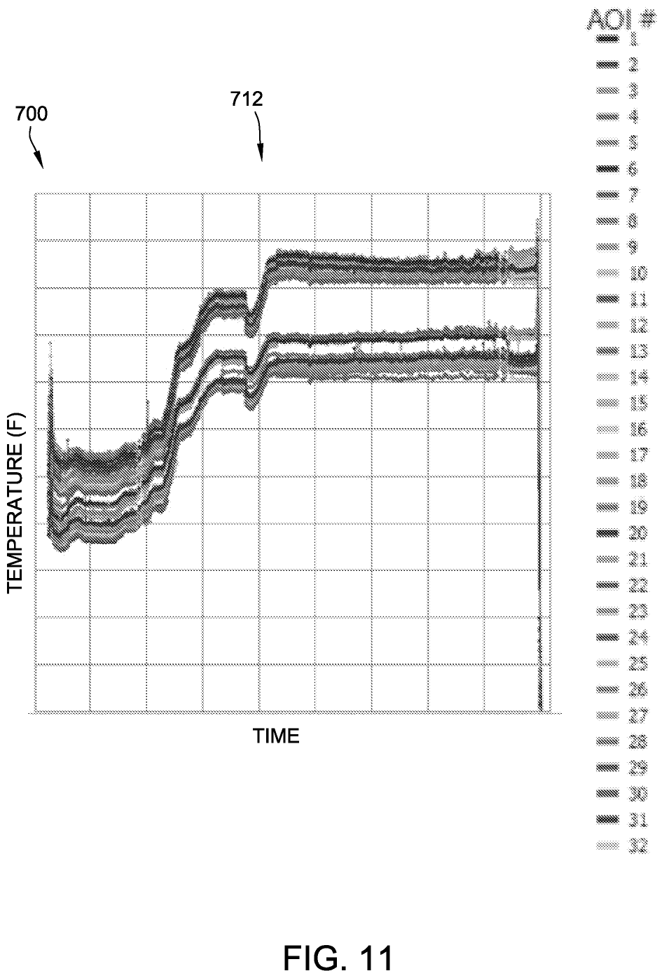

FIG. 7 is a display 700 displayed on user interface 150 showing raw images 702 of blades 118. FIG. 8 is a display 700 displayed on user interface 150 showing images 704 of blades 118 including at least one area of interest 706. FIG. 9 is a display 700 displayed on user interface 150 showing images 708 of blades 118 including areas of interest 706. FIG. 10 is a display 700 displayed on user interface 150 showing a real-time temperature profile 710 of blades 118. FIG. 11 is a display 700 displayed on user interface 150 showing a graph 712 of a temperature of area of interest 706 of blades 118. In the exemplary embodiment, user interface 150 includes display 700 configured to display images 702, 704, and 708, temperature profile 710, and graph 712. Additionally, processor 214 is configured to identify areas of interest 706 within images 702, 704, and 708 and displays areas of interest 706 for the user to inspect. Processor 214 may also calculate an average temperature intensity of each area of interest 706 and display the average temperature intensity in graph 712. Areas of interest 706 may identify temperature anomalies, cracks, and/or other defects on blades 118. As such, areas of interest 706 may alert a user to regions on blades 118 that may need maintenance.

Additionally, single-pixel detector enables prism 202, optical transportation device 204, and detector unit 206 to be smaller than prism 202, optical transportation device 204, and detector unit 206 with a focal plane array such that at least prism 202 and optical transportation device 204 are able to be inserted into a smaller hole, such as borescope holes, within turbine assembly 100. As such, thermal imaging system 102 may be installed in turbine assembly 100 during normal operations, and images 702, 704, and 708, temperature profile 704, and/or graph 712 may be displayed in real time on user interface 150 for real time feedback. The temperature data may also be sent to an engine controller that computes real-time feedback on engine operating conditions. The real-time feedback may be used as input to an alarm system that alerts an operator when a temperature of a component of turbine assembly 100 is outside a predetermined temperature range.

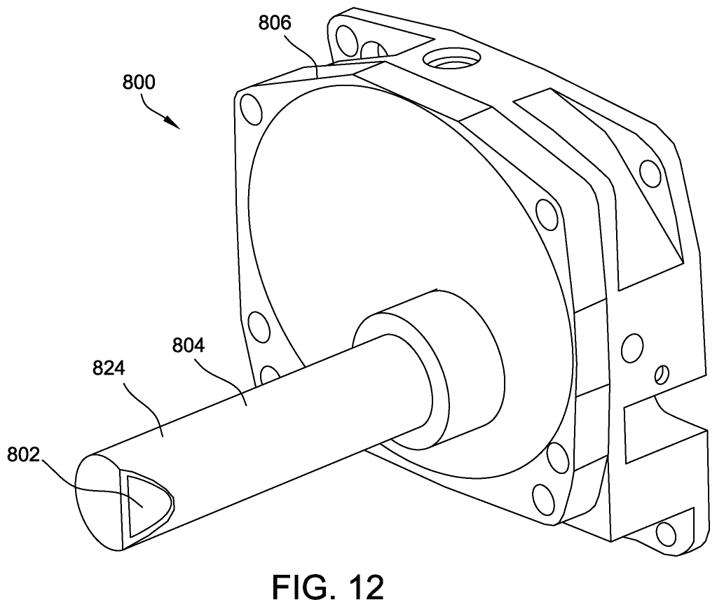

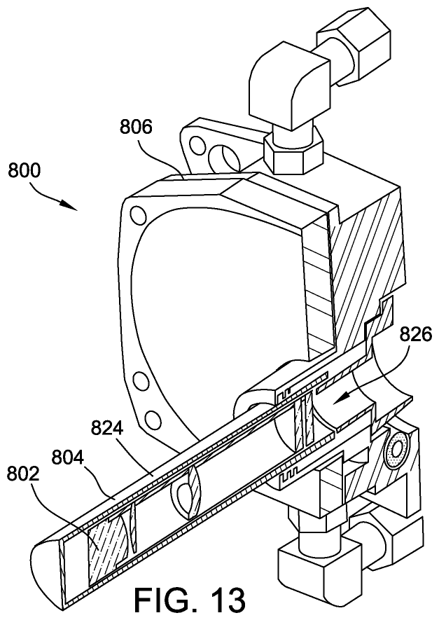

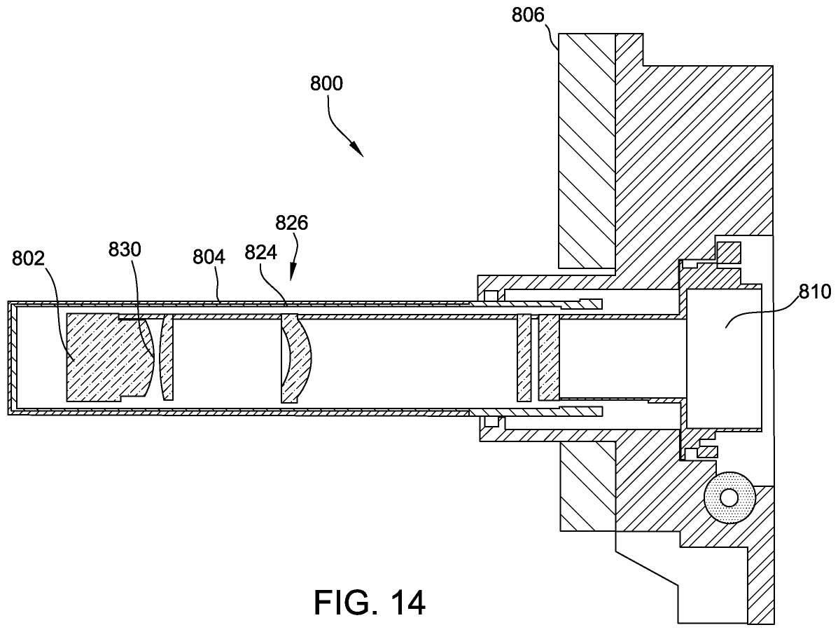

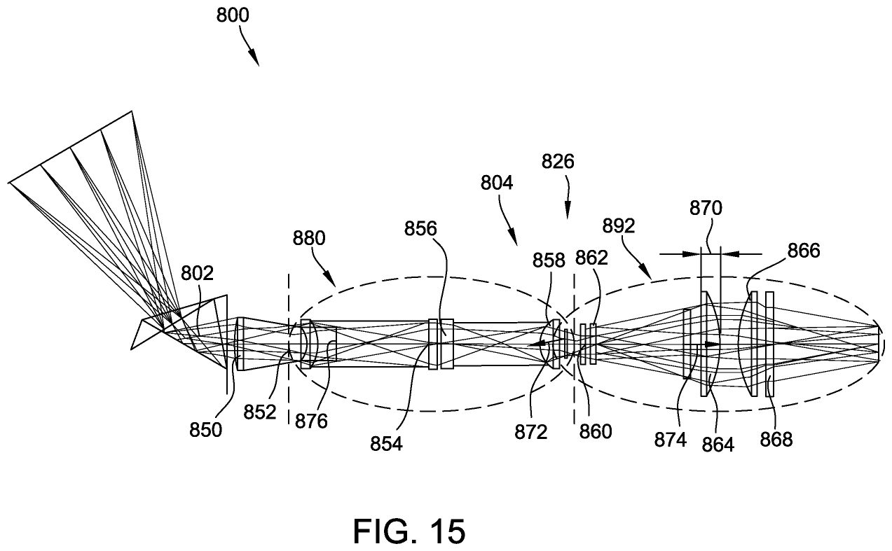

FIG. 12 is a perspective view of a third thermal imaging system 800 including a second prism 802, a third optical transportation device 804, and a second detector unit 806. FIG. 13 is a perspective cut-away view of third thermal imaging system 800. FIG. 14 is a side cut-away view of third thermal imaging system 800. FIG. 15 is a schematic view of second prism 802 and third optical transportation device 804. Third thermal imaging system 800 is substantially similar to thermal imaging system 102 except for the differences described herein. Specifically, second prism 802 has a different shape than prism 202, third optical transportation device 804 includes a specific arrangement of optical elements 826, and second detector unit 806 includes a focal plane array detector 810 configured to image the entire blade 118. More specifically, in the exemplary embodiment, second prism 802 includes a curved output face 830 configured to improve optical performance of third thermal imaging system 800. Second prism 802, third optical transportation device 804, and second detector unit 806 are configured to improve the optical performance of third thermal imaging system 800. More specifically, second prism 802 and the arrangement of optical elements 826 within a tube 824 of third optical transportation device 804 improves the optical performance of third thermal imaging system 800 such that the quality of the images acquired by third thermal imaging system 800 is up to twenty times better than the quality of the images acquired by thermal imaging system 102.

In the exemplary embodiment, third optical transportation device 804 includes a plurality of optical elements 826 configured to improve the optical performance of third optical transportation device 804. More specifically, third optical transportation device 804 includes a first lens 850, a second lens 852, a third lens 854, a fourth lens 856, a fifth lens 858, a sixth lens 860, a seventh lens 862, an eighth lens 864, a ninth lens 866, and a tenth lens 868 arranged in tube 824. In the exemplary embodiment, lenses 850-868 are formed of either sapphire and/or silicon. In alternative embodiments, lenses 850-868 are formed of any material that enables third optical transportation device 804 to operate as described herein. In the exemplary embodiment, lenses 852-868 are formed of silicon and first lens 850 is formed of sapphire. Each lens 850-868 defines a thickness 870, an input face radius 872, an output face radius 874, and a diameter 876. Table 1 lists thickness 870, input face radius 872, output face radius 874, and diameter 876 for each lens 850-868 and for second prism 802. In the exemplary embodiment, tube 824 has a diameter sized and shaped for insertion into small borescope holes within turbine assembly 100. As such, tube 824 has a small diameter.

TABLE 1
Thickness, Input Face Radius, Output Face Radius, and Diameter for
Each Lens and for the Prism

| | Radius | Thickness | Glass | Diameter |
|---|---|---|---|---|
| Lens Number | (mm) | (mm) | Material | (mm) |
| Distance from Object | PLANO | 54.900 | Air | N/A |
| Plane to Prism Entrance | | | | |
| Prism Thickness | | 9.300 | SAPPHIRE | N/A |
| Prism Exit Curvature | 21.595 | 1.000 | | 17.05 |
| Lens 1 | −26.675 | 3.000 | SAPPHIRE | 14.73 |
| | PLANO | 20.640 | | 14.73 |
| Lens 2 | 13.284 | 4.000 | SILICON | 12.60 |
| | 14.080 | 37.109 | | 14.73 |
| Lens 3 | −57.727 | 4.000 | SILICON | 14.73 |
| | 49.176 | 1.000 | | 14.73 |
| Lens 4 | 30.803 | 4.000 | SILICON | 13.84 |
| | 78.044 | 29.287 | | 14.73 |
| Lens 5 | −9.896 | 5.111 | SILICON | 14.73 |
| | −7.141 | 5.117 | | 9.91 |
| Lens 6 | −7.703 | 2.000 | SILICON | 13.00 |
| | −6.361 | 7.684 | | 11.00 |
| Lens 7 | 21.138 | 2.000 | SILICON | 11.00 |
| | 16.167 | 39.550 | | 13.00 |
| Lens 8 | 67.110 | 4.000 | SILICON | 27.61 |
| | 43.516 | 6.400 | | 30.99 |
| Lens 9 | −43.516 | 4.000 | SILICON | 30.99 |
| | −67.110 | 6.000 | | 27.61 |
| Lens 10 | 204.457 | 2.000 | SILICON | 28.18 |
| | PLANO | | | 30.99 |
| Distance to Image Plane | PLANO | 36.000 | Air | N/A |

In the exemplary embodiment, lenses 852-858 define a collimated relay telescope portion 880 of third optical transportation device 804, and lenses 860-868 define a correction optics portion 892 of third optical transportation device 804. Collimated relay telescope portion 880 is configured to compress electromagnetic radiation 222 into tube 824 with a small diameter. Correction optics portion 892 is configured to correct for optical aberrations and field curvature enabling a high-performance image to be cast onto focal plane array detector 810.

Second prism 802 and first lens 850 are formed of sapphire because sapphire has a higher melting temperature and can survive higher temperatures than silicon. However, lenses 852-868 are formed of silicon because silicon has a higher index, reduces optical aberrations, and increases the optical performance of third optical transportation device 804. Additionally, silicon has a melting temperature that is about 75% that of the melting temperature of sapphire and can easily survive in the lower temperatures within third optical transportation device 804. Moreover, as shown in FIG. 14, a case and third optical transportation device 804 of third thermal imaging system 800 are configured to channel a flow of air to second prism 802 and into turbine assembly 100. The flow of air is configured to cool third optical transportation device 804 and second prism 802 such that a temperature of lenses 850-868 and second prism 802 is maintained below a melting temperature of lenses 850-868 and second prism 802. Additionally, third optical transportation device 804 defines a plurality of vent holes positioned proximate second prism 802. The vent holes are configured to channel the flow of air into turbine assembly 100 and cool second prism 802.

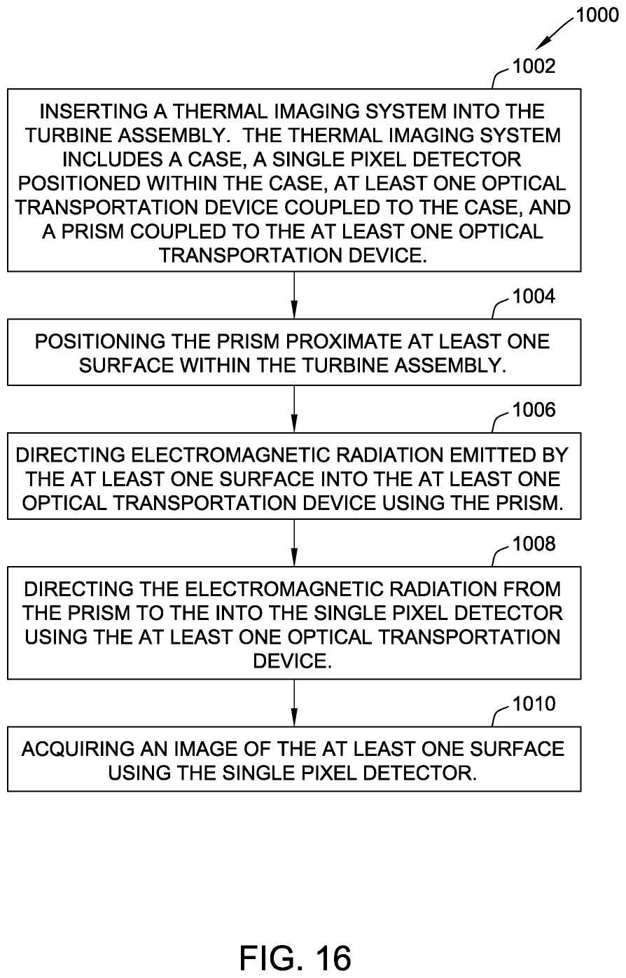

FIG. 16 is a flow diagram of a method 1000 of maintaining a turbine assembly. The method includes inserting 1002 a thermal imaging system into the turbine assembly. The thermal imaging system includes a case, a single pixel detector positioned within the case, at least one optical transportation device coupled to the case, and a prism coupled to the at least one optical transportation device. The method also includes positioning 1004 the prism proximate at least one surface within the turbine assembly. The method further includes directing 1006 electromagnetic radiation emitted by the at least one surface into the at least one optical transportation device using the prism. The method also includes directing 1008 the electromagnetic radiation from the prism to the into the single pixel detector using the at least one optical transportation device. The method further includes acquiring 1010 an image of the at least one surface using the single pixel detector.

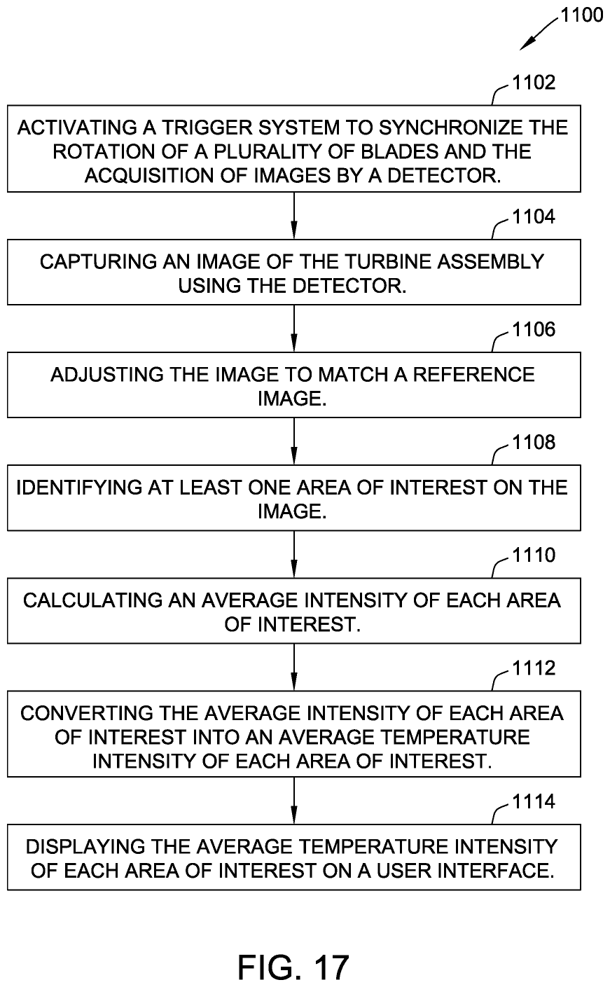

FIG. 17 is a flow diagram of a method 1100 of acquiring and displaying data associated with a turbine assembly. The method 1100 includes activating 1102 a trigger system to synchronize the rotation of a plurality of blades and the acquisition of images by a detector. The method 1100 also includes capturing 1104 an image of the turbine assembly using the detector. The method 1100 further includes adjusting 1106 the image to match a reference image. The method 1100 also includes identifying 1108 at least one area of interest on the image. The method 1100 further includes calculating 1110 an average intensity of each area of interest. The method 1100 also includes converting 1112 the average intensity of each area of interest into an average temperature intensity of each area of interest. The method 1100 also includes displaying 1114 the average temperature intensity of each area of interest on a user interface.

The above described embodiments provide a thermal imaging system for use in maintaining rotary machines. The thermal imaging system includes a detector and/or an optical transportation device that is small enough to enable the thermal imaging system to be inserted into small borescope holes within the turbine assembly. More specifically, in a first embodiment, the thermal imaging system includes a single-pixel detector sized and shaped to allow at least a portion of the thermal imaging system to be inserted into small borescope holes within the turbine assembly. The single pixel detector has a small field of view (1 square millimeter (mm) or less) and measures only a single point within the turbine assembly at a given time. The small field of view allows electromagnetic radiation to travel through a small diameter optical transportation device and a small diameter hole in turbine assembly. Small borescope holes within the turbine assembly allow the thermal imaging system to be used with existing turbine assemblies. Accordingly, using a single pixel detector enables a size of the optical transportation device to be reduced to fit within small borescope holes within the turbine assembly. Additionally, the single pixel detector does not require as much cooling as other detectors, such as focal plane array detectors. As such, a small thermal electric cooler can be used to cool the thermal imaging system, allowing the thermal imaging system to be inserted into small borescope holes within the turbine assembly. Furthermore, the optical transportation device may include fiber optic cables that enable increased access to difficult-to-reach locations within the turbine assembly and reduces the amount of time the rotary machine is out of service for maintenance. Finally, the thermal imaging system may be installed within the turbine assembly during normal operations. Accordingly, the thermal imaging system provides real-time feedback on the turbine assembly operating conditions.

An exemplary technical effect of the methods, systems, and apparatus described herein includes at least one of: (a) reducing the time to inspect and/or repair rotary machines; (b) increasing the accessibility of difficult-to-reach locations within a turbine assembly for inspection and/or in situ repair; (c) reducing the time that rotary machines are out of service for maintenance; (d) increasing the precision and reliability of inspection and/or repair of rotary machines; (e) reducing unplanned service outages for a rotary machine; (f) enabling the extension of periods between planned service outages of a rotary machine for inspection and/or repair; and (g) enhancing data capture for use in quantifying and/or modeling the service condition of at least some components of the rotary machine.

Exemplary embodiments of methods, systems, and apparatus for maintaining rotary machines are not limited to the specific embodiments described herein, but rather, components of systems and/or steps of the methods may be utilized independently and separately from other components and/or steps described herein. For example, the methods, systems, and apparatus may also be used in combination with other systems requiring inspection and/or repair of components and are not limited to practice with only the systems and methods as described herein. Rather, the exemplary embodiment can be implemented and utilized in connection with many other applications, equipment, and systems that may benefit from using a thermal imaging system for inspection and/or repair.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A thermal imaging system for use in maintaining a turbine assembly, said thermal imaging system comprising:
a case;
a single pixel detector positioned within the case;
at least one optical transportation device coupled to the case and configured to direct electromagnetic radiation to the single pixel detector; and
a prism coupled to the at least one optical transportation device and configured to direct electromagnetic radiation into the at least one optical transportation device and to the single pixel detector, wherein at least the prism and the at least one optical transportation device are inserted into the turbine assembly and the single pixel detector acquires images of the turbine assembly.

2. The thermal imaging system in accordance with claim 1, wherein the at least one optical transportation device comprises a tube configured to direct electromagnetic radiation to the single pixel detector.

3. The thermal imaging system in accordance with claim 2, wherein the at least one optical transportation device further comprises at least one optical element positioned within the tube.

4. The thermal imaging system in accordance with claim 3, wherein the at least one optical element comprises at least one lens.

5. The thermal imaging system in accordance with claim 2, wherein the prism is coupled to a first end of the tube.

6. The thermal imaging system in accordance with claim 1, wherein the prism comprises a sapphire prism.

7. The thermal imaging system in accordance with claim 1, wherein the prism is configured to refract electromagnetic radiation into the at least one optical transportation device.

8. The thermal imaging system in accordance with claim 1 further comprising a cooler configured to cool at least one of the single pixel detector, the at least one optical transportation device, and the prism.

9. The thermal imaging system in accordance with claim 8, wherein the cooler comprises a thermal electric cooler.

10. The thermal imaging system in accordance with claim 8, wherein the cooler comprises a liquid nitrogen cooler.

11. The thermal imaging system in accordance with claim 1, wherein the at least one optical transportation device comprises at least one fiber optic cable.

12. The thermal imaging system in accordance with claim 11, wherein the at least one fiber optic cable comprises a plurality of fiber optic cables.

13. A thermal imaging system for use in maintaining a turbine assembly, said thermal imaging system comprising:
a case;
a focal plane array detector positioned within the case;
an optical transportation device coupled to the case and configured to direct electromagnetic radiation to the focal plane array detector, wherein the optical transportation device comprises a plurality of optical elements; and
a prism coupled to the optical transportation device and configured to direct electromagnetic radiation into the optical transportation device and to the focal plane array detector, wherein at least the prism and the optical transportation device are inserted into the turbine assembly and the focal plane array detector acquires images of the turbine assembly.

14. The thermal imaging system in accordance with claim 13, wherein the optical transportation device further comprises a tube.

15. The thermal imaging system in accordance with claim 14, wherein the plurality of optical elements comprises ten optical elements arranged in the tube.

16. The thermal imaging system in accordance with claim 15, wherein the ten optical elements comprise ten lenses arranged in the tube.

17. The thermal imaging system in accordance with claim 13, wherein the prism comprises a curved output face.

18. The thermal imaging system in accordance with claim 13, wherein the case and the optical transportation device are configured to channel a flow of air to the prism and into the turbine assembly, wherein the flow of air is configured to cool the optical transportation device and the prism.

19. The thermal imaging system in accordance with claim 18, wherein the optical transportation device defines a plurality of vent holes positioned proximate the prism, wherein the plurality of vent holes are configured to channel the flow of air into the turbine assembly.

20. A method of maintaining a turbine assembly, said method comprising:
inserting a thermal imaging system into the turbine assembly, wherein the thermal imaging system comprises:
a case;
a single pixel detector positioned within the case;
at least one optical transportation device coupled to the case; and
a prism coupled to the at least one optical transportation device;
positioning the prism proximate at least one surface within the turbine assembly;
directing electromagnetic radiation emitted by the at least one surface into the at least one optical transportation device using the prism;
directing the electromagnetic radiation from the prism to the into the single pixel detector using the at least one optical transportation device; and
acquiring an image of the at least one surface using the single pixel detector.
